(19) United States
(12) Patent Application Publication
(10) Pub. No.: US 2024/0046397 A1
(43) Pub. Date: Feb. 8, 2024

(54) REAL-TIME ACCOUNT ANALYTICS FOR DETECTING FRAUDULENT ACTIVITY

(71) Applicant: Verint Americas Inc., Alpharetta, GA (US)

(72) Inventors: Tim McCurry, Duluth, GA (US); Joshua Tindal Gray, Reston, VA (US); Wade Walker Ezell, Woodstock, GA (US); Ryan Thomas Schneider, Decatur, GA (US); Andrew Jabasa, San Diego, CA (US)

(21) Appl. No.: 17/880,154

(22) Filed: Aug. 3, 2022

(51) Int. Cl. G06Q 50/26; G06F 21/62

(52) U.S. Cl. CPC G06Q 50/265; G06F 21/6245

(57) ABSTRACT

A system for detecting fraudulent activity using account analytics obtains an interaction record for an interaction between a remote device and a user account via an interaction channel, where the interaction is an attempt to access the user account, obtains historical data relating to the user account and the interaction channel that includes one or more historical interaction records relating to the user account and activity records relating to the interaction channel, calculates a threat score for the user account based on the interaction record and the one or more historical interaction records that indicates a likelihood that the user account is subject to fraudulent activity, generates a database record based on the interaction record that includes the threat score, and initiates corrective action if the threat score exceeds a predetermined threshold.

### FIELD

The present disclosure generally relates to fraud detection, particularly in customer self-service channels.

### BACKGROUND

As the name implies, customer self-service is the process by which customers (e.g., users) service their accounts (e.g., access or change account information, solve issues, etc.) without assistance from customer service agents. Customer self-service channels are the communication channels that provide customers with access to accounts for self-servicing. Mobile applications, automated chat bots, automatic call centers, and the like are all examples of self-service communication channels. For example, a customer may call an automated call center or system in order to access account information, make account changes, etc. While convenient for customers, self-service channels can be prone to attack by fraudulent actors, and affected institutions are often unaware of fraudulent activity via these channels. In some cases, institutions take actions against an access point (e.g., Automatic Number Identification (ANI), IP address, etc.) that attempts to access a user account; however, current solutions leave private customer data vulnerable to exploitation.

### SUMMARY

One implementation of the present disclosure is a system for detecting fraudulent activity using account analytics. The system includes one or more processors and memory having instructions stored thereon that, when executed by the one or more processors, cause the system to obtain an interaction record for an interaction between a remote device and a user account via an interaction channel, the interaction including an attempt to access the user account, obtain historical data relating the user account and the interaction channel that includes one or more historical interaction records relating to the user account and activity records relating to the interaction channel, calculate a threat score for the user account based on the interaction record and the one or more historical interaction records that indicates a likelihood that the user account is subject to fraudulent activity, generate a database record based on the interaction record that includes the threat score, and initiate corrective action if the threat score exceeds a predetermined threshold.

In some implementations, the instructions further cause the system to obtain a risk score for the interaction channel, the threat score being calculated based further on the risk score.

In some implementations, the corrective action comprises suspending the user account to prevent access.

In some implementations, the corrective action includes one of blocking or blacklisting the interaction channel.

In some implementations, the instructions further cause the system to generate and display a user interface that indicates details of the interaction and the threat score.

In some implementations, the interaction record is obtained from a client device via an application programming interface (API).

In some implementations, the interaction record includes channel activity data for the interaction channel, authentication activity data relating to the user account, and behavioral activity data relating to the interaction.

In some implementations, the behavioral activity data includes one or more of a time of day of the interaction, an indication of the number of access attempts made against the user account, an indication of an attempt to change security details of the user account, a length of the interaction, and an indication of whether a user of the remote device attempted to transfer to a customer service agent.

In some implementations, the interaction and the historical data relating to the user account and the interaction channel are obtained in real-time such that the threat score is calculated in real-time or near real-time.

In some implementations, the threat score is calculated using a machine learning model, and the machine learning model is continuously retrained based on interaction data and user account data.

Another implementation of the present disclosure is a method for detecting fraudulent account activity. The method includes obtaining an interaction record for an interaction between a remote device and a user account via an interaction channel, the interaction being an attempt to access the user account, obtaining historical data relating the user account and the interaction channel that includes one or more historical interaction records relating to the user account and activity records relating to the interaction channel, calculating a threat score for the user account based on the interaction record and the one or more historical interaction records indicating a likelihood that the user account is subject to fraudulent activity, generating a database record based on the interaction record that includes the threat score, and initiating a corrective action if the threat score exceeds a predetermined threshold.

In some implementations, the method further includes obtaining a risk score for the interaction channel, wherein the threat score is calculated based further on the risk score.

In some implementations, the corrective action includes one of suspending the user account to prevent access, blocking the interaction channel, or blacklisting the interaction channel.

In some implementations, the method further includes generating and displaying a user interface that indicates details of the interaction and the threat score.

In some implementations, the interaction record is obtained from a client device via an application programing interface (API).

In some implementations, the interaction record includes channel activity data for the interaction channel, authentication activity data relating to the user account, and behavioral activity data relating to the interaction.

In some implementations, the behavioral activity data includes one or more of a time of day of the interaction, an indication of number of access attempts made against the user account, an indication of an attempt to change security details of the user account, a length of the interaction, and an indication of whether a user of the remote device attempted to transfer to a customer service agent.

In some implementations, the interaction and the historical data relating the user account and the interaction channel are obtained in real-time such that the threat score is calculated in real-time or near real-time.

In some implementations, the threat score is calculated using a machine learning model that is continuously retrained based on interaction data and user account data.

Yet another implementation of the present disclosure is a non-transitory computer readable medium having instructions stored thereon that, when executed by one or more processors of a computing device, cause the computing device to obtain an interaction record for an interaction between a remote device and a user account via an interaction channel, the interaction being an attempt to access the user account, obtain historical data relating the user account and the interaction channel that includes one or more historical interaction records relating to the user account and activity records relating to the interaction channel, calculate a threat score for the user account based on the interaction record and the one or more historical interaction records indicating a likelihood that the user account is subject to fraudulent activity, and initiate a corrective action if the threat score exceeds a predetermined threshold.

Additional features will be set forth in part in the description which follows or may be learned by practice. The features will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Various aspects, features, and of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example customer self-service communication architecture, according to some implementations.

FIG. 2 is a block diagram illustrating a high-level fraud detection architecture, according to some implementations.

FIG. 3 is a detailed block diagram of an account scoring system, according to some implementations.

FIG. 4 is a flow diagram of a process for identifying fraudulent activity based on user account data, according to some implementations.

FIG. 5 is an example user interface for configuring various parameters of the account scoring system of FIG. 3, according to some implementations.

FIG. 6 is an example user interface of a fraud portal for displaying threat scores and other related data, according to some implementations.

FIG. 7 is a block diagram of a high-level architecture of a call risk assessment system, according to some implementations.

### DETAILED DESCRIPTION

Referring generally to the figures, a system and methods for detecting fraudulent self-service activity based on user account data are shown, accordingly to various implementations. In particular, the system and methods described herein can be used to monitor interactions via automated call distribution (ACD) systems, interactive voice response (IVR) systems, intelligent virtual agents (IVAs), or the like, for fraudulent activity. As mentioned above, self-service accounts can be vulnerable to attacks from fraudulent actors that exploit account features, as self-service accounts tend to allow for account access from remote devices without service agent intervention. Banking customers, for example, may call an automated call center to change account information, access account balance details, request fund transfers, etc., without input from a customer service agent. Existing technologies for detecting fraudulent activity tend to identify malicious access points (e.g., self-service channels) and may take action against the access point itself, but are generally not capable of taking action at an account level. For example, existing solutions may identify phone numbers, Internet Protocol (IP) addresses, and the like that are suspected of being fraudulent but do not identify the user account(s) that are being attacked, which can be problematic if an account is subject to multiple attacks. In some cases, for example, fraudsters may attack an account from multiple access points (e.g., using different phone numbers or IP addresses), which can leave the account vulnerable.

In contrast, the system and methods described herein provide more robust account security by leveraging live and historical account-level data to generate threat assessments for the user accounts themselves. Specifically, when an attempt to access a user account is detected and/or recorded, data relating to interaction and to the user account itself is analyzed using a scoring model to generate a threat score indicative of risk to the account. If fraud is suspected, the system and methods described herein may take corrective action, such as by suspending or locking the user account, transmitting or displaying alerts, and modifying the interaction flow. Additionally, records of fraudulent activity can be generated to increase security against future attacks. Notably, the system described herein is externally accessible via an Application Programming Interaction (API), which allows the system to be remotely accessed by other interaction monitoring or fraud detection systems. The system and methods described herein are also data-driven and automated, needing little to no human interaction once operational. Additional features of the system and methods described herein are also described in greater detail below.

### Overview

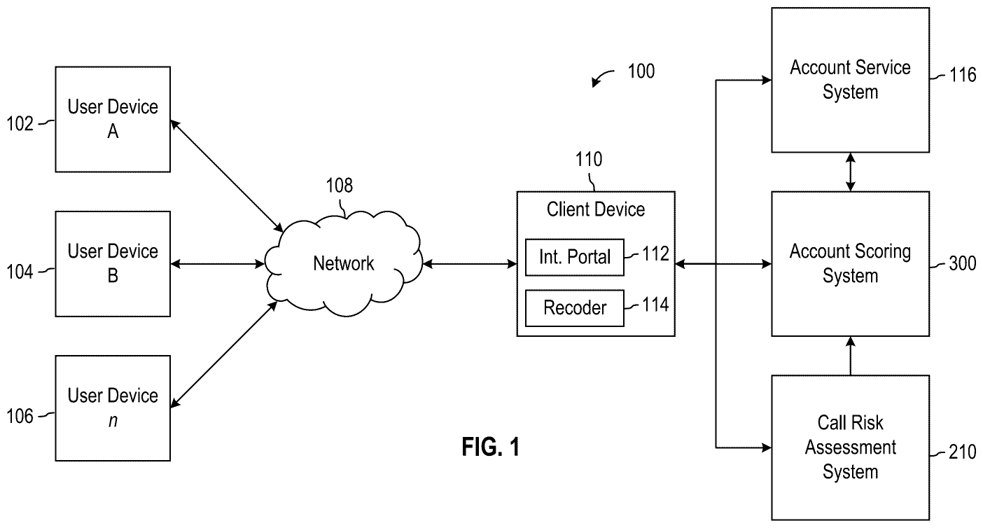

Turning first to FIG. 1, a block diagram of an example customer self-service communication architecture 100 is shown, according to some implementations. At a high level, communication architecture 100 represents a flow of data when a user or users attempt to access a user account. As shown, multiple user devices 102-106 may each represent a user device attempting to access a user account, or various different accounts, via client device 110. User devices 102-106, as described herein, may represent any devices operable by a user to access a user account. For example, user devices 102-106 may be telephones, smartphones, smart watches, computers, tablets, or the like. In some implementations, user devices 102-106 may communicate with client device 110 via a network 108, which may be any suitable type of communication network, e.g., a network over which data can be communicated between two or more devices. In some implementations, network 108 is a telecommunications network, such as a cellular network, a telephone network, a radio network, an intranet, the Internet, etc. In some implementations, network 108 represents a mixture of network types. For example, user device 102 may communicate via a cellular network while user device 104 communicates via the Internet. In some such implementations, other remote computing devices (e.g., servers), which are not shown, may handle the transfer of data between network types. It should be appreciated that network 108 is not limited to the examples provided herein.

Client device 110 generally represents a computing device or computing system operated by an institution that provides customer support, products, and/or services to customers. For example, client device 110 may be operated by a business, a call center, etc. As an example, client device 110 may be a call center server. Client device 110 is shown to include an interaction portal 112 and, optionally, a recorder 114. Interaction portal 112 is generally an interface through which users of user devices 102-106 interact with other back-end systems, as described below. In the context of the present disclosure, interaction portal 112 is, or includes, an ACD system, an IVR system, an IVA, or the like. Accordingly, interaction portal 112 may receive audio or digital data from one or more of user devices 102-106, depending on the communication method initiated by user devices 102-106, and may provide automated responses back to the corresponding user device. As an example, responsive to a user-initiated interaction (e.g., a phone call, a chat, an email chain, etc.), interaction portal 112 may provide automated prompts that guide the user through a menu of account options and/or may retrieve and present request information. It should be appreciated that, while interaction portal 112 is shown as a component of client device 110, in some implementations, interaction portal 112 is hosted on a separate computing device.

In some implementations, recorder 114 generates a record of each interaction (e.g., phone call, email, text, message, etc.). Each interaction record may include details about the interaction, such as a date and/or time the interaction was initiated, a length of interaction, a channel address, an account identifier (e.g., if the user attempts to access an account), etc. In some implementations, interaction records are stored in a database on client devices 110 or another computing device for later use. For example, interaction records may be retrieved by one or more back-end systems for use in fraud detection, as described below. One such back-end system, which is in communication with client device 110, is an account service system 116. Account service system 116 is generally a computing device (e.g., a server) or group of computing devices that securely maintains user account data. In some implementations, account service system 116 may be a system/device operated and/or owned by any third-party business or service provider that provides users with individual accounts (e.g., a bank, an insurance company, a streaming service, etc.). As shown, client device 110 may communicate with account service system 116 in order to retrieve account data and/or make account changes. Accordingly, while shown as separate components, in some implementations, client device 110 and account service system 116 may be hosted on a common device (e.g., a server).

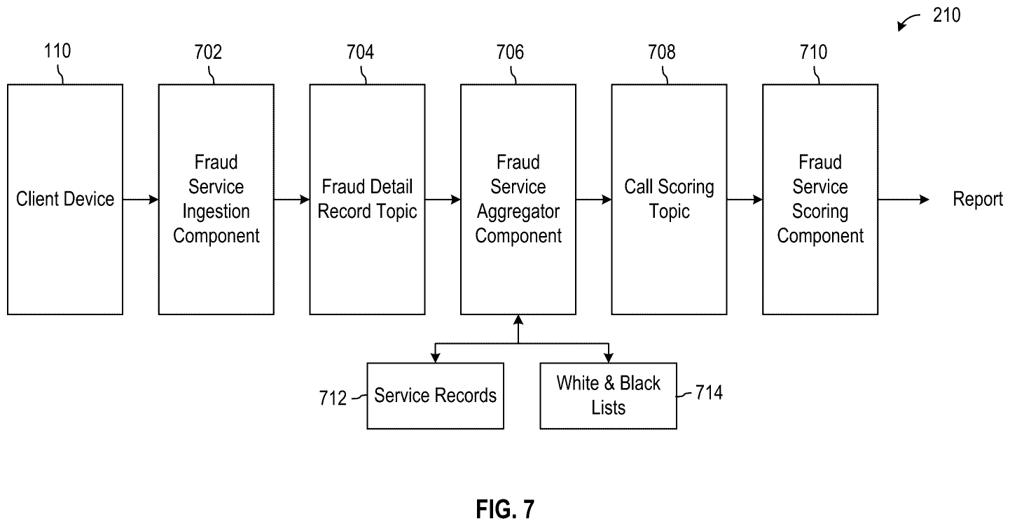

In some implementations, client device 110 and/or account service system 116 are also in communication with an account scoring system 300. As described in greater detail below, account scoring system 300 is generally configured to detect possible fraudulent activity against a user account based on interaction records (e.g., generated by client device 110) and historical account data (e.g., maintained by account service system 116). In some implementations, account scoring system 300 generates a threat score indicative of the likelihood of fraudulent activity against a user account. Further, in some implementations, account scoring system 300 initiates corrective actions to protect the user account. In some implementations, account scoring system 300 obtains additional data for generating the threat score from a call risk assessment system 210. The additional data may include, for example, a separate risk score generated by call risk assessment system 210 based on interaction data, such as the channel or access point used to initiate the interaction. Call risk assessment system 210 is described in detail below with respect to FIG. 7. Additional details of call risk assessment system 210 are generally disclosed in U.S. Pat. No. 11,240,372, filed Jan. 4, 2021, which is incorporated herein by reference in its entirety.

To better explain communication architecture 100, a use-case example is provided herein. Say, for example, that a customer of a business wishes to update account information or to otherwise access their account data remotely. The customer, using a user device such as user device 102-106, may call a customer service number associated with the business to be connected to client device 110, which may be a computing device operated by the business or a third-party contracted by the business to handle customer service (e.g., a call center). Client device 110 may route the call to an IVR system, such as interaction portal 112, to allow the customer to self-service their account. Throughout the interaction, interaction portal 112 may interpret the customer's speech (e.g., using a natural language processing (NLP) model) in order to provide prompts or other options to the customer (e.g., menu options, etc.). Interaction portal 112 may query account service system 116 in order to retrieve or access account data, which can then be provided to the customer. Meanwhile, recorder 114 may make a record of the interaction. As the interaction is occurring, call risk assessment system 210 and/or account scoring system 300 may evaluate the interaction record and, in the case of account scoring system 300, the customer's account history, to determine whether the customer is acting fraudulently.

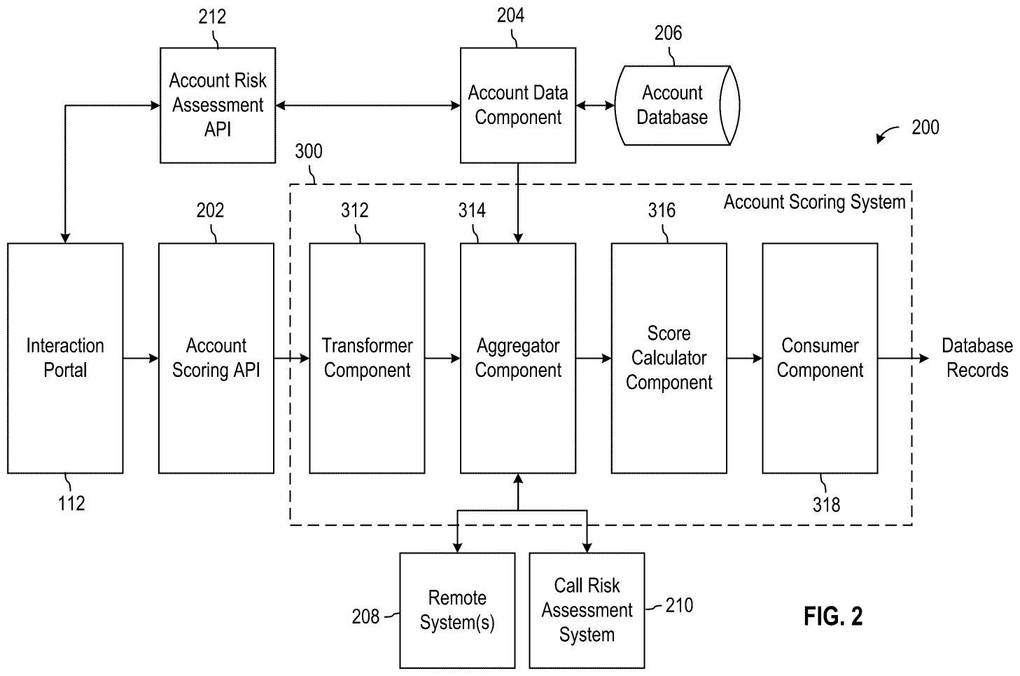

Referring now to FIG. 2, a block diagram illustrating a high-level fraud detection architecture 200 is shown, according to some implementations. In some respects, architecture 200 illustrates the interaction between client device 110 and account scoring system 300 when analyzing a customer interaction. As described above, when a user (e.g., a customer) initiates an interaction (e.g., a call, a chat, etc.) with client device 110, an interaction record may be generated. The interaction record may include various information relating to the interaction, such as the time and date of the interaction, a length of the interaction, a channel from which the interaction was initiated (e.g., a phone number, an ANI, an IP address, etc.), an account identifier (e.g., a hashed account number), an interaction record ID, etc. As shown, interaction portal 112 may call an account scoring API 202 to initiate analysis of an interaction record and may transmit to system 300 via account scoring API 202, the interaction record. As described herein, account scoring API 202 may be a REST API or other suitable API. In some implementations, communications between interaction portal 112 and account scoring API 202 are secured, such as with a token. It should be appreciated, as well, that interaction portal 112 may generally represent any system that interacts with a user via a channel (e.g., an IVR or ACD system, etc.).

In some implementations, client device 110 initiates the generation of a threat score by transmitting a request to account scoring API 202. The data included in the request is shown in Table 1.

TABLE 1
Request Data

| Field Name | Mandatory | Data Type | Cardinality | Definition |
|---|---|---|---|---|
| application | Yes | String | 1 | Application name - must be unique |
| | | | | within the domain of the organization |
| division | No | String | 1 | Division within the organization |
| organization | Yes | String | 1 | Organization name |
| accountHash | Yes | String | 1 | Account number. Must be securely |
| | | | | hashed if considered sensitive/PII. |
| channel | Yes | String | 1 | Channel from which event originated |
| | | | | (ex. ANI) |
| channelAddress | Yes | String | 1 | Specific address from which event |
| | | | | originated (ex. 7035551212) |
| appLogId | Yes | String | 1 | Application Log ID - is unique and |
| | | | | identifies the call |

An example request is provided below.

```
{
  “accountHash” :
  “4c68xudjmg09389u90a696d1c4a1be5aa6536756754371fa94c0aadff411”,
  “channel” : “ani”,
  “channelAddress” : “7035551212”,
  “application” : “Router”,
  “organization” : “ACME”,
  “division” : “Rocket”,
  “appLogId” : “20220101153000_SRVR0710_PORT123”
}
```

Account scoring API 202, having received a request and interaction record from interaction portal 112 or another device, may pass the interaction record to account scoring system 300. More specifically, the interaction record may be received by a transformer component 312 that enriches the interaction record with context data. Context data generally refers to any data that is collected during an interaction that provides additional interaction information. For example, a topic or summary of the interaction may be collected or determined as context data. Additionally, in some implementations, transformer component 312 may ensure that the interaction record is in an appropriate format for further processing. For example, transformer component 312 may change the type or format of data in the interaction record.

An aggregator component 314 may receive the enriched data from transformer component 312 and may gather additional interaction and account data to be aggregated with the interaction record, including from remote systems 208. Remote systems 208 can generally include any devices or systems that are remote to account scoring system 300. Account service system 116, for example, may be one of remote systems 208. As shown, for example, the aggregation component may collect historical account data via an account data component 204. Account data component 204 may, in particular, serve as a gateway to an account database 206, which includes historic data relating to various user accounts. For example, account database 206 may include a previously-determined threat score for each known account. In some implementations, account database 206 includes an account watchlist, which is a list of accounts that were previously flagged as “high risk.” As described in greater detail below, an account may be flagged as “high risk” if the threat score generated by system 300 meets or exceeds a threshold value.

As shown, aggregator component 314 may also receive additional interaction data from call risk assessment system 210. As mentioned above, call risk assessment system 210 is generally configured to separately detect potentially fraudulent activity based on the channel being used to access an account (e.g., the ANI, IP address, etc.) rather than by considering account data. For example, call risk assessment system 210 may generate a risk score for the channel address that is used to access the account. In this manner, aggregator component 314 may combine a channel-side evaluation of an interaction with the interaction record to provide a more robust threat assessment. In some implementations, aggregator component 314 may also receive or retrieve (e.g., from a database (not shown)) interaction records and channel alerts. In some such implementations, channel alerts may be received from call risk assessment system 210 or from other systems or databases. Channel alerts, similar to the account flags mentioned above, are tags that indicate channels (e.g., ANIs, IP address, etc.) suspected of fraudulent activity or that were associated with fraudulent activity in the past. The interaction records received by aggregator component 314 are generally historic interaction records relating to both the channel being used to access the account and, in some cases, the account itself.

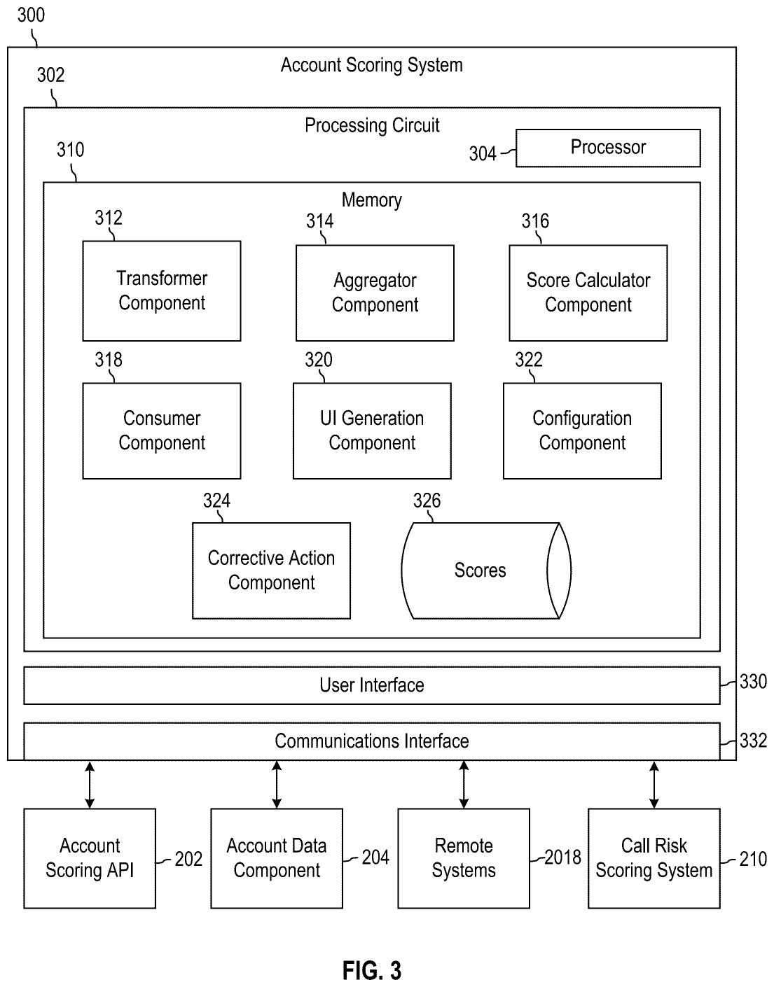

In some implementations, the aggregated call risk assessment data, historical account data, and historical channel data are forwarded to a score calculator component 316, which calculates a threat score for the account. Score calculator component 316 may, in particular, consider various activity types relating to the account and interaction to calculate the threat score, including channel activity, authentication activity, and behavioral activity, which are discussed in greater detail below with respect to FIG. 3. The threat score generated by score calculator component 316 may be a numerical value (e.g., a risk level from 1-5, a percentage, etc.) indicative of the likelihood that an account access attempt was fraudulent. In some cases, the threat score may be a binary value (e.g., “fraudulent” or “not fraudulent”), and/or score calculator component 316 may convert a numerical score into text (e.g., “low” or “high”).

In some implementations, a consumer component 318 may process the output of score calculator component 316 (e.g., the threat score) to generate a series of database records. In general, database records are then stored and/or forward to various remote devices. In some such implementations, database records are transmitted to account data component 204 for storage in account database 206. The database records may link the account information (e.g., a hashed account number), channel information, and threat score. In some implementations, database records are maintained for later reporting and auditing. For example, system 300 may maintain these records and/or the records may be transmitted to, or accessed by, various client devices. In some implementations, database records are provided to client device 110 in response to the request initiated via an account assessment API 212. Account assessment API 212 may interface client device 110 and/or interaction portal 112 with account data component 204, such that client device 110 may freely retrieve account records. In this manner, users of client device 110 may be directly informed about the potential risk of an account that a caller is trying to interact with even before a threat score is generated.

In some implementations, database records are utilized to generate alerts and/or user interfaces that can be presented to various users to identify fraudulent activity. An example database record or response to a request is shown in Table 2.

TABLE 2
Example Database Record/Response

| Field Name | Data Type | Cardinality | Definition |
|---|---|---|---|
| application | String | 1 | Application name |
| division | String | 1 | Division within the organization |
| organization | String | 1 | Organization name |
| accountHash | String | 1 | Account number |
| channel | String | 1 | Channel from which event originated |
| channelAddress | String | 1 | Specific address from which event originated |
| appLogId | String | 1 | Application Log ID |
| risk | String | 1 | Calculated risk for the account: |
| | | | NONE (for closed accounts only) |
| | | | VERYLOW |
| | | | LOW |
| | | | MEDIUM |
| | | | HIGH |
| | | | VERYHIGH |
| score | Integer | 1 | Score aligned with risk level, on a scale from 0 |
| | | | (NONE) to 5 (VERYHIGH) |
| status | String | 1 | Status of the account: |
| | | | VALID: normal account |
| | | | WATCHLIST: potentially risky account |
| | | | sent to Sentry Watchlist for further |
| | | | analysis) |
| | | | IN_REVIEW: account placed “Under |
| | | | Review” in the Verint Call Risk Scoring |
| | | | Service Portal |
| | | | LEGITIMATE: account has been |
| | | | reviewed and confirmed legitimate in the |
| | | | Verint Call Risk Scoring Service Portal |
| | | | INACTIVE: account set as “Closed” in the |
| | | | Verint Call Risk Scoring Service Portal |

An example database record or response is provided below.

```
{
  “accountHash” :
“4c68ef38b4d3d5697b85c3a696d1c4a1be5aa6536756754371fa94c0aadff411”,
  “channel” : “ani”,
  “channelAddress” : “7035551212”,
  “application” : “Router”,
  “organization” : “ACME”,
  “division” : “Rocket”,
  “appLogId” : “20220101153000_SRVR0710_PORT123”,
  “risk” : “LOW”,
  “score” : 2,
  “status” : “VALID”
}
```

### Account Scoring System

Referring now to FIG. 3, a detailed block diagram of account scoring system 300 is shown, according to some implementations. System 300 is shown to include a processing circuit 302 that includes a processor 304 and a memory 310. Processor 304 can be a general-purpose processor, an application specific integrated circuit (ASIC), one or more field programmable gate arrays (FPGAs), a group of processing components, or other suitable electronic processing components. In some implementations, processor 304 is configured to execute program code stored on memory 310 to cause system 300 to perform one or more operations. Memory 310 can include one or more devices (e.g., memory units, memory devices, storage devices, etc.) for storing data and/or computer code for completing and/or facilitating the various processes described in the present disclosure.

In some implementations, memory 310 includes tangible, computer-readable media that stores code or instructions executable by processor 304. Tangible, computer-readable media refers to any media that is capable of providing data that causes the system 300 (e.g., a machine) to operate in a particular fashion. Example tangible, computer-readable media may include, but is not limited to, volatile media, non-volatile media, removable media, and non-removable media implemented in any method or technology for storage of information such as computer readable instructions, data structures, program modules, or other data. Accordingly, memory 310 can include random access memory (RAM), read-only memory (ROM), hard drive storage, temporary storage, non-volatile memory, flash memory, optical memory, or any other suitable memory for storing software objects and/or computer instructions. Memory 310 can include database components, object code components, script components, or any other type of information structure for supporting the various activities and information structures described in the present disclosure. Memory 310 can be communicably connected to processor 304, such as via processing circuit 302, and can include computer code for executing (e.g., by processor 304) one or more processes described herein.

While shown as individual components, it will be appreciated that processor 304 and/or memory 310 can be implemented using a variety of different types and quantities of processors and memory. For example, processor 304 may represent a single processing device or multiple processing devices. Similarly, memory 310 may represent a single memory device or multiple memory devices. Additionally, in some implementations, system 300 may be implemented within a single computing device (e.g., one server, one housing, etc.). In other implementations, system 300 may be distributed across multiple servers or computers (e.g., that can exist in distributed locations). For example, system 300 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by two or more computers. For example, virtualization software may be employed by system 300 to provide the functionality of a number of servers that is not directly bound to the number of computers in system 300.

As described above with respect to FIG. 2, account scoring API 202 may route interaction records to system 300 from various client devices, such as client device 110. In some implementations, interaction records are received in the form of a threat assessment request, an example of which is provided above. Generally, data from external sources, including account scoring API 202, is received via a communications interface 332. At a high level, communications interface 332 facilitates communications between system 300 and any external components or devices. Put another way, communications interface 332 is responsible for sending (e.g., transmitting) and receiving data. For example, communications interface 332 can provide means for transmitting data to, or receiving data from, account scoring API 202 and/or account assessment API 212, along with other devices and systems.

Accordingly, communications interface 332 can be or can include a wired or wireless communications interface (e.g., jacks, antennas, transmitters, receivers, transceivers, wire terminals, etc.) for conducting data communications. In various implementations, communications via communications interface 332 may be direct (e.g., local wired or wireless communications) or via a network (e.g., a WAN, the Internet, a cellular network, etc.), such as network 108. For example, communications interface 332 can include an Ethernet transceiver transmitting and receiving data via a wired (e.g., Ethernet) connection, for transceivers for communicating via a wireless communications network. In another example, communications interface 332 can include a WiFi transceiver for communicating via a wireless communications network. In yet another example, communications interface 332 may include cellular or mobile phone communications transceivers.

As described briefly above, memory 310 is shown to include transformer component 312 that enriches the interaction record with context data, and/or ensures that the interaction record is in an appropriate format for further processing. Context data generally refers to any data that is collected during an interaction that provides additional interaction information. In some implementations, as mentioned above, transformer component 312 may change the type or format of data in the interaction record. In some implementations, transformer component 312 further handles the initial processing of a request received from client device 110. For example, transformer component 312 may extract relevant data from the request and provide instructions to other components of system 300.

Aggregator component 314, as described above, generally receives the enriched interaction data from transformer component 312 and aggregates it with additional data from account data component 204, call risk assessment system 210, and any additional account/interaction databases. In some implementations, aggregator component 314 receives or retrieves data from remote systems 208, such as account service system 116. More generally, aggregator component 314 combines the current or real-time interaction data received as part of a request for generating a threat score with historical account and channel data. Historical data generally includes alerts relating to the user account and channel that initiated account access, historical interaction records, and the like.

After aggregation, score calculator component 316 may generate the threat score. In some implementations, score calculator component 316 implements a rule-based scoring algorithm to generate the threat score. The rule-based algorithm may, in particular, assign values to various interaction data. In some implementations, score calculator component 316 considers three main areas when calculating the threat score: channel activity, authentication activity, and behavioral activity. While various datapoints may be interpreted from an interaction record itself, it should also be appreciated that context data collected by transformer component 314 (e.g., as mentioned above) may also be useful in evaluating authentication and behavioral activity with respect to both a user account and the channel attempting to access the account.

As mentioned above, a channel is defined as the device or source that is initiating activity (e.g., an attempt to access a user account). In a digital environment, a channel may be an IP address, while in a telephony environment, the channel is the ANI or phone number of the calling party, for example. To this point, score calculator component 316 considers all of the channel activity directed to the specific user account. In some implementations, channel activity is scored by a separate system or device, such as call risk assessment system 210, which returns a channel score. For example, a high risk channel may have been scored as “red” or “high” by call risk assessment system 210. In this manner, score calculator component 316 may account for risks from the channel-side of an interaction.

Authentication activity generally relates to attempts to authenticate the user for access to the user account. In particular, score calculator component 316 may assess the method of authentication and the success/failure of the authentication. For example, if a caller tries multiple times to authenticate for access to an account but always fails authentication multiple times, score calculator component 316 may determine that the authentication activity is indicative of fraudulent activity. Similarly, if an account holder always authenticates using one method (e.g., account number and PIN) but the user attempting to access the account uses another method (e.g., social security number and date of birth), this could also be an indication of risk.

Behavioral activity relates to the user's interaction with the user account, either prior to or after gaining account access. The score calculator component 316 may consider, for example, the time of day that the user attempted to access the account, call sequencing (e.g., the number of times that the user attempted to access the account), number of requests to transfer to an agent, attempts to change an account password or PIN, length of the interaction, and more. Calling at 3 AM to check an account balance, for example, may be an indication of fraudulent activity, as well as making multiple calls in a relatively short period of time accessing the same account. Excessive agent transfer can be a strong indicator of a fraudster trying to social engineer an agent. It should be appreciated that various other behavioral indicators may also be considered.

In some implementations, score calculator component 316 includes a machine learning model that determines the threat score. In particular, the machine learning model may be provided with interaction data, as outlined above, as an input and may output a threat score. In some such implementations, the machine learning model may be a neural network, a deep neural network, etc. In some implementations, score calculator component 316 utilizes various machine learning models to assign scores to the various channel, authentication, and behavioral data described above. In some implementations, score calculator component 316 may continuously retrain or update the machine learning model based on interaction data and/or account data. For example, the machine learning model may be retrained over time as new information is gathered relating to a user account and/or channel. In some implementations, the machine learning model is retrained based, in part, on user inputs. For example, when a threat is detected and/or a threat score is provided to a user, the machine learning model may be updated based on how the user addresses the threat. In some cases, the user may simply be alerted to the potential threat, and the machine learning model may be updated based on the user's indication of whether or not the threat was real.

As mentioned above, consumer component 318 may process the output of score calculator component 316 (e.g., the threat score) to generate a series of database records. In some implementations, scores may be transmitted via account data component 204 in order to update account database 206. These database records can then be used to generate a report, which can be displayed with a user interface and/or otherwise presented to a user (e.g., via a user device). In some implementations, scores are stored in a scores database 326. Additionally, or alternatively, scores may be transmitted to user devices (e.g., client device 110) for display.

An example report is provided below in Table 3. In this example, account numbers are provided in a hashed or otherwise obfuscated format to protect account data. “Score” indicates the threat score; “total channels” indicates the number of different channels (e.g., ANIs, IPs) that attempted to access the account; “high risk channels” and “medium risk channels” indicate the number of channels that were scored as high or medium risk, respectively, by call risk assessment system 210; “time of day” indicates the number of times that the channel attempted to access the account during predefined off-hours; “RePIN’ indicates whether the user attempted to change the account PIN; “Xfer LS PIN Invalid” indicates that the user tried to transfer to an agent after the PIN was determined to be invalid; and “Burst 24” indicates the number of calls to the account in a 24 hour period.

TABLE 3
Example Database Record

| | | | High | Med. | | | | Xfer | |
|---|---|---|---|---|---|---|---|---|---|
| | | Total | Risk | Risk | Time | EP: UPS | | LS PIN | Burst |
| Account | Score | Channels | Channels | Channels | of Day | Tracking | RePIN | Invalid | 24 |
| 10012525 | 5 | 4 | 0 | 4 | 0 | 15 | 0 | 0 | 10 |
| 1003132 | 5 | 5 | 0 | 5 | 0 | 0 | 1 | 0 | 13 |
| 10037361 | 5 | 6 | 1 | 5 | 3 | 0 | 0 | 0 | 20 |
| 10079856 | 5 | 6 | 1 | 5 | 0 | 1 | 0 | 0 | 0 |
| 10081523 | 5 | 6 | 0 | 5 | 0 | 0 | 1 | 0 | 0 |
| 10084713 | 5 | 6 | 0 | 5 | 0 | 0 | 5 | 0 | 14 |

In some implementations, memory 310 further includes a user interface (UI) generation component 320 for generating various user interfaces. Specifically, UI generation component 320 can generate graphical user interfaces (GUIs) to present data, including the database record and/or threat scores generated by consumer component 318. In some implementations, UI generation component 320 can generate GUIs that include text, graphs, graphics, charts, interactive elements, and the like. In some implementations, the GUIs generated by UI generation component 320 are transmitted to various user devices, which cause the various user devices to display the GUIs. In some implementations, system 300 includes a user interface 330 for displaying GUIs and other information. User interface 330 generally includes a screen (e.g., an LED or LCD screen) for displaying GUIs. In some implementations, user interface 330 includes one or more devices that allow a user to interact with system 300, such as a mouse, a keyboard, a keypad, a touchscreen, etc.

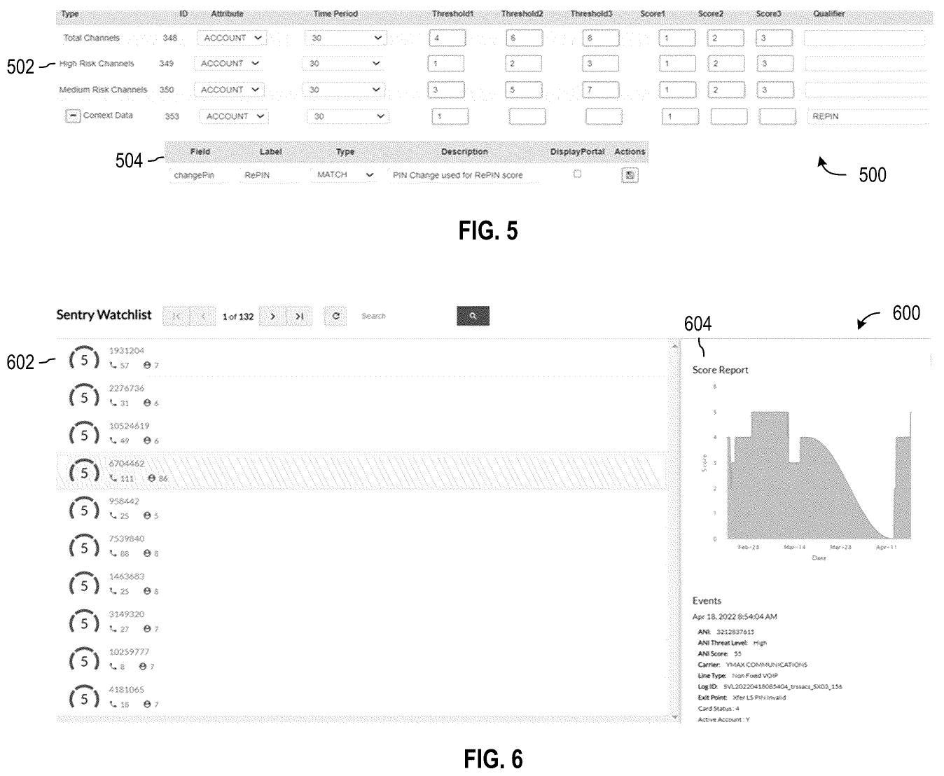

Still referring to FIG. 3, in some implementations, memory 310 includes a configuration component 322. Configuration component 322 is generally configured to establish, or change, various configuration parameters for score generation. In some embodiments, users can interaction indirectly with configuration component 322 to change various parameters. An example user interface for changing configuration settings is shown in FIG. 5. For example, users may be able to change the rules used to score an account. In the example of FIG. 5, described in detail below, the user may set thresholds for the number of channels attempting to access an account that would be considered “risky.” In some implementations, users can set values to be assigned if various rules are determined to be true.

In some implementations, memory 310 includes a corrective action component 324 that initiates corrective actions based on the calculated threat scores. In particular, corrective action component 324 may initiate corrective actions if a threat score for an account meets or exceeds a threshold value. In some implementations, corrective action component 324 is configured to suspend the user account if the threat score meets the threshold. For example, if the threat score is 4 or 5, on a scale of 0-5, then corrective action component 324 may suspend the account. In this way, the account may be locked from access by outside parties to protect account data. In some implementations, corrective action component 324 blocks or blacklists the channel attempting to access the account. Blocking the channel can prevent the channel from accessing the target account or any other accounts. Similarly, blacklisting the channel adds the channel to a database of known fraudulent channels.

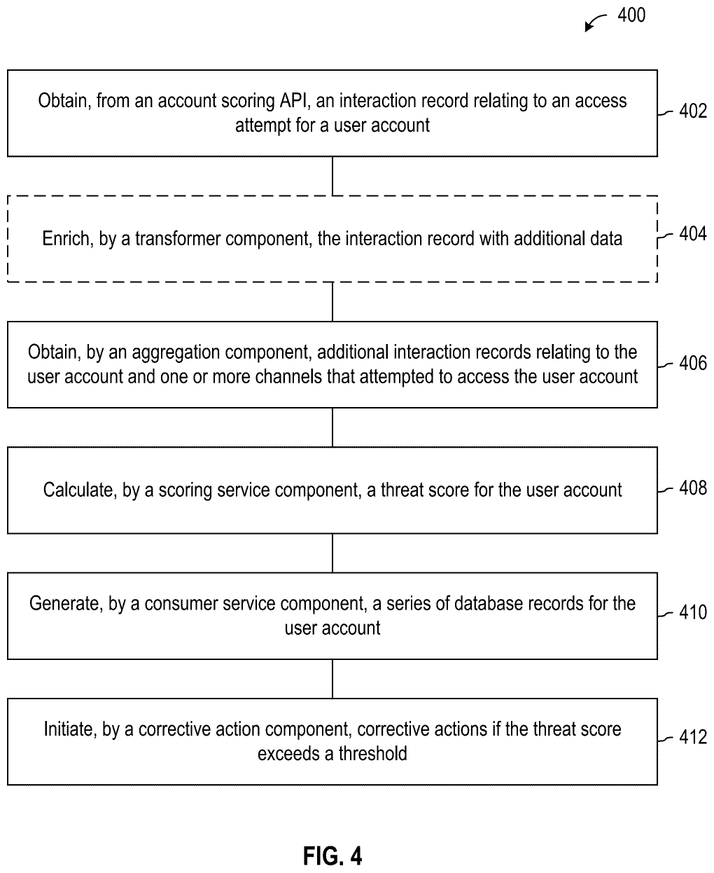

Referring now to FIG. 4, a flow diagram of a process 400 for identifying fraudulent activity based on user account data is shown, according to some implementations. In some implementations, process 400 is implemented by system 300, as described above. It should be appreciated that all of process 400, or certain portions of process 400, may be performed by other computing devices. It will also be appreciated that certain portions of process 400 may be optional and, in some implementations, process 400 may be implemented using less than all of the illustrated blocks.

At block 402, an interaction record relating to an access attempt for a user account is obtained. In some implementations, the interaction record is obtained by system 300 from account scoring API 202. As described above, account scoring API 202 may act as a gateway for one or more client devices (e.g., client device 110), which handle self-service interactions, to request analysis of an interaction for fraudulent activity. For example, multiple client devices may utilize system 300 remotely as a fraud detection service. Accordingly, while only one interaction record is described herein for simplicity's sake, it should be appreciated that system 300 may process any number of interaction records. For example, client device 110 may record details of multiple interactions, which are then batch processed by system 300. To this point, it should also be appreciated that the interaction may be obtained in real-time (e.g., during the interaction or at the start of the interaction) or after the interaction has occurred. In any case, as described above, the interaction may include various details about the interaction, such as an identifier for the account being accessed, an identifier for the channel accessing the account (e.g., the ANI), a channel address, an identifier for the interaction record, a length of the interaction, etc. In some implementations, the interaction record may include a request, generated by client device 110, to generate a threat score. An example request is provided above in Table 1.

At block 404, the interaction record is optionally enriched with additional data by transformer component 312. As mentioned above, transformer component 312 may append the interaction record with context data and/or convert the transaction record into an appropriate format for further processing. In some implementations, transformer component 312 collects data from outside sources to enrich the interaction record. For example, transformer component 312 may collect additional details about the interaction from client device 110. In some implementations, only a request for fraud detection is received at block 402, in which case transformer component 312 may retrieve the interaction record from client device 110.

At block 406, historical interaction records relating to both the target user account and the interaction channel that attempted to access the account are obtained. In some implementations, the additional interaction records are obtained by aggregator component 314. As described above, aggregator component 314 may retrieve historical account records from an account database 206. The historical account records may indicate whether the account has been flagged for fraudulent activity in the past, historical or current threat scores, and the like. It should be noted that, as described herein, system 300 may only have access to hashed or otherwise secure account numbers, so as to protect user account information. In this case, aggregator component 314 may query account data component 204 using the hashed account number in order to access account records.

In some implementations, aggregator component 314 may retrieve a risk score for the interaction channel from a separate channel scoring system. The risk score for the interaction channel may indicate a likelihood that the channel is being used fraudulently. For example, an ANI or IP address may be flagged for repeated attempts to access one or more user accounts. To this point, aggregator component 314 may also determine whether there exists any channel alerts relating to the interaction channel that is attempting to access the user account. A channel alert may be a flag that is placed on interaction channels that are determined or suspected to be fraudulent. In some implementations, aggregator component 314 also gathers historical interaction records relating to both the target user account and the interaction channel. The historical interactions records may indicate past account access attempts directed to the user account and/or originating from the interaction channel. For example, historical interactions records may be used to determine how various behavioral activity, such as how often the account is being accessed, when the account is usually accessed, what accounts the interaction channel has accessed in the past, etc.

At block 408, score calculator component 316 calculates a threat score for the user account. As mentioned above, in some implementations, score calculator component 316 implements a rule-based scoring algorithm that assigns values to various interaction data to determine the threat score. In some implementations, score calculator component 316 uses a machine learning model to calculate the threat score. In either case, score calculator component 316 generally considers three main areas when calculating the threat score, including channel activity, authentication activity, and behavioral activity, as described above. These main categories are generally indicated in the interaction record obtained at block 402. In some implementations, the threat score is a numerical value, such as a number between 0 and 5, where ‘0’ is a very low likelihood that the interaction is fraudulent and ‘5’ is a very high likelihood that the interaction is fraudulent. It should be appreciated that the threat score may be calculated in real-time or near real-time, based on when the interaction record is obtained. For example, if the interaction record is obtained in real-time (e.g., during the interaction), the threat score may be calculated immediately. In some cases, interaction records may be obtained after the interaction (e.g., for batch processing), in which case the threat score is not calculated until after the interaction has occurred.

At block 410, consumer component 318 generates database records based on the interaction record and the threat score. Database records are generally linked data or entries in a database that include the threat score and, in some cases, details relating to the interaction. For example, a database record may include an account identifier (e.g., hashed account number), the calculated threat score, and various additional interaction and account detail. In some implementations, database records are used to generate reports, which can be displayed with a user interface and/or otherwise presented to a user (e.g., via a user device). An example report, which indicates some of the information included in a database record, is shown about in Table 3.

In some implementations, process 400 further includes generating and displaying a user interface that indicates the threat score and additional account/interaction details. An example user interface is shown in FIG. 6, described below. In some such implementations, the database record generated at block 410 is used to generate the user interface. In some implementations, the database record is accessed remotely by a user device (e.g., client device 110) or is transmitted to a remote user device, which can cause the user device to generate and display a user interface. Similarly, in some implementations, a report may be transmitted to a user device which causes the user device to display a user interface.

At block 412, a corrective action is initiated with the threat score exceeds a threshold. In some implementations, the correction action(s) are initiated by corrective action component 324. In particular, corrective action component 324 may initiate corrective actions if a threat score for an account meets or exceeds a threshold value. In some implementations, corrective action component 324 is configured to suspend the user account if the threat score meets the threshold. For example, if the threat score is 4 or 5, on a scale of 0-5, then corrective action component 324 may suspend the account. In this way, the account may be locked from access by outside parties to protect account data. In some implementations, corrective action component 324 blocks or blacklists the channel attempting to access the account. Blocking the channel can prevent the channel from accessing the target account or any other accounts. Similarly, blacklisting the channel adds the channel to a database of known fraudulent channels. In some implementations, the corrective action includes generating and transmitting or displaying an alert that indicates to a user that possible fraudulent activity was detected.

Referring now to FIG. 5, an example user interface 500 for configuring various parameters of account scoring system 300 is shown, according to some implementations. Generally, interface 500 is used to set rules for determining the threat score for an account. Accordingly, interface 500 is shown to include a plurality of interactive graphical elements (e.g., menus, text boxes, icons, etc.) for each rule 502 with which a user can interact to enter or change rules/parameters. Looking to the “high risk channels” row, for example, a user can view of modify an attribute, time period, threshold values, and default scores. Element 504 is shown to include various additional editable field such as field, label, type, and description.

Referring now to FIG. 6, an example user interface 600 of a fraud portal for displaying threat scores and other related data is shown, according to some implementations. In some implementations, interface 600 is an example of a user interface generated by UI generation component 320 and displayed via user interface 330. As shown, interface 600 includes a watchlist 602 of accounts and their associated threat scores. For example, account 1931204 has a threat score of ‘5’. As mentioned above, it should be appreciated that the account numbers displayed via interface 600 may be encoded or hashed to protect user data. In other words, the account numbers shown may be reference numbers only and may not be actual account numbers. Each list entry also includes various data associated with each account, such as a number of interactions (e.g., calls) associated with the account (e.g., a number of times the account was accessed) and a number of unique user devices that have accessed the account. Additionally, interface 600 includes a score report 604 that includes a chart indicating the change in a selected account's threat score over time. In some implementations, score report 604 further includes interaction event details, such as a date and time of an interaction (e.g., a call), the ANI that initiated the interaction, the ANI's threat level, etc.

### Call Risk Assessment System

As described above, in some implementations, system 300 may obtain channel risk score from call risk assessment system 210. In general, call risk assessment system 210 evaluates interaction data from the channel-side of an interaction. Specifically, call risk assessment system 210 may score the channel (e.g., ANI, IP address, etc.) that is attempting to access a user account. Put another way, rather than producing a threat score indicative of a likelihood that a user account is subject to fraud, call risk assessment system 210 assesses whether the channel that is attempting to access the user account is fraudulent. Thus, combining the channel risk score generated by call risk assessment system 210 with the threat score generated by system 300 can result in more robust fraud detection and security.

Referring now to FIG. 7, a high-level architecture of call risk assessment system 210 is shown, according to some implementations. Data is generally described herein as moving through system 210 from left to right, for the sake of clarity. As data moves through system 210, it is assessed in multiples stages using, security checks, format checks, conditionals, data aggregation for enriching events with context data, and thresholds checks, as well as more advanced machine learning techniques.

As shown, client device 110 may provide interaction data (e.g., an interaction record) to a fraud service ingestion component 702. In some implementations, client device 110 is communicably coupled to fraud service ingestion component 702 via an API (not shown). In some such implementations, the API connection is secured via a token. In some implementations, fraud service ingestion component 702 is, itself, an API for ingesting interaction records. For example, fraud service ingestion component 702 may be a REST API containing a high-speed pub-sub data producer that can quickly publish interaction data out to a topic that is subscribed to by listening consumers that store and aggregate the data. Additionally, upon receipt of the interaction data, fraud service ingestion component 702 is generally configured to check and/or correct the format of the data.

Once determined to be valid, or once in an appropriate format for further processing, fraud service ingestion component 702 may forward the data to a fraud detail record topic 704. Fraud detail record topic 704 is a pub/sub high speed data pipe used to distribute channel address events to multiple endpoints for processing. Of note, any service can generally subscribe to the events (e.g., interaction data) via fraud detail record topic 704. In this case, there is only one event (e.g., an interaction); however, any number of events can be processed by fraud detail record topic 704. Subsequently, a fraud service aggregator component 706 receives the interaction data from the published topic and augments the event with additional context data. In some implementations, fraud service aggregator component 706 checks the event channel address against a white and black lists 714, and the augmented event is forwarded on to a call scoring topic 708. In some implementations, fraud service aggregator component 706 may also retrieve additional information about a channel (e.g., an ANI, an IP address, etc.), for example, how many contacts from that channel in a predetermined period of time (e.g., over a 30, 60, or 90-day period). Such additional information may be retrieved from a service records database 712.

In some implementations, call scoring topic 708 is subscribed to by multiple scoring services, including a fraud service scoring component 710. Depending on the channel address in use, multiple scoring services can be used to check for multiple broad or very specific attack vectors. Extending the process of a high-volume system to multiple parallel and replicated services assists in allowing the events that need actions are forwarded on to call scoring topic 708. The scoring processes can be simple threshold checks or more advanced ML based solutions. Some of the categories include simple thresholds checks (e.g., how many times has a caller attempted to access the systems and how many accounts have they accessed), behavioral checks (e.g., What type of behavior do they exhibit over short periods of access or over longer terms? How do they deviate from the expected pattern of normal use?), and situational checks (e.g., What channel address (IP or Number) are they calling from? what is the history of that channel address? Where are they calling from? Is the location of the caller suspect or from a location where services and user normally call from? etc.). Based on a potentially large list of factors, from simple counts to more complicated machine learning based predictions, a level of threat is used to determine if the call should be forwarded for analysis.

In general, call risk assessment system 210 utilizes three main approaches, including conditional processing, standard deviation in an unsupervised learning model, and weighted averages. Behaviors, situation and reputation are all processed via weighted averages. Behaviors are qualified via a calculation that determines how far they are from the mean. All others are qualified by configuration, in some cases by an analyst. Scores from all are used in combination scoring, which generates an overall risk score that may be used to determination whether a report on the channel address is propagated to the fraud report service and the dashboard for further action and review in real-time. Combination scores are calculated by the combination of threat scoring, behavioral scoring, situational scoring, and reputation scores. The combination of scores is entirely configurable and interchangeable and often dependent on the channel address type and what data is available from it. Before scores are calculated, modus ponens with forward chaining is used. Due to the use of multiple channel address types and the availability of data, the need for a diverse rule set is required.

If conditional process doesn't redirect the process, the scoring process is started. Behavior counts are processed via weighted averages of the percent deviation from the mean or expected behavior. All others (situational and reputation) are calculated using weighted averages. Rules can be added and included in processing as new data becomes available via configuration step. In general, fraud service scoring component 710 starts with the data and reasons its way to the answer. It can do this by combining one or many rules weighting the outcomes of each and concluding a risk level. The effect of this method is an ability to add and apply combinations of rule sets to generate the likelihood of fraud. It also allows for easy addition of new rules as the fraudsters apply new attack vectors. For a given channel address there can be one to n rule combinations that, when combined, provide a channel risk score.

In general, fraud service scoring component 710 can score as many data points as needed, based on the channel type producing a report for a given channel address. This process is dependent on the channel address and the information it provides. Example scoring types include: threat scoring (e.g., external blacklist) based on third-party ANI blacklist and IP blacklist requests; threat scoring (e.g., internal blacklist/whitelist) based on application, customer, and local ANI blacklist and IP blacklist; and behavior scoring using standard deviation and weighted averages. In some implementations, threat scoring based on application, customer, and local ANI blacklist and IP blacklist is combined with the threat scoring based on third-party ANI blacklist and IP blacklist requests. In some implementations, behavior scoring considers various datapoints, which may be assessed at multiple threshold levels, such as whether the user attempted to access multiple accounts, the total call/access attempts, length of calls, number of failed authentication/account locks, re-pin/password reset requests, whether multiple SSNs or emails are accessed, and number of exit points (e.g., where does a channel address exit?).

In some implementations, fraud service scoring component 710 may utilize situational scoring based on weight averages. In such embodiments, service scoring component 710 may utilize caller ID, IP whois, Autonomous System Number (ASN) lookup, Geographic (GEO) IP look up, white pages lookup for scoring. These scores may be used individually or combined in any number or combinations to increase specificity and sensitivity, such as line-type, device type, browser user agent/device signature/accept language Hypertext Transfer Protocol (HTTP) headers, location, carrier verification, address verification (if available), ASN verification, billing address, distance between GEO IP and address, country, email address/domain/age/trace, IIN, IP tenure, phone number, address distance, time of day, and so on.

In some implementations, fraud service scoring component 710 may utilize reputation scoring. For example, new channel addresses tend to be riskier than those known. A channel address is considered new if it hasn't been used in the last 90/180 days, for example. An age qualifier can be used to determine either a single threat level or multiple. For example, a channel that is not seen in 180 days equates to a threat level=75, not seen in 90 days equates to a medium threat=50, and finally not seen in 45 days equates to minimum threat 30.

### Configuration of Certain Implementations

The construction and arrangement of the systems and methods as shown in the various exemplary implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the exemplary implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems are chosen based on designer choice. All such variations are within the scope of the disclosure. Likewise, software implementations could be accomplished with standard programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an,” and “the” include plural referents unless the context clearly dictates otherwise. Ranges may be expressed herein as from “about” one particular value and/or to “about” another particular value. When such a range is expressed, another embodiment includes from the one particular value and/or the other particular value. Similarly, when values are expressed as approximations, by use of the antecedent “about,” it will be understood that the particular value forms another embodiment. It will be further understood that the endpoints of each of the ranges are significant both in relation to the other endpoint and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc., of these components are disclosed, that while specific reference of each various individual and collective combinations and permutations of these may not be explicitly disclosed, each is specifically contemplated and described herein, for all methods and systems. This applies to all aspects of this application, including, but not limited to, steps in disclosed methods. Thus, if there are a variety of additional steps that can be performed, it is understood that each of these additional steps can be performed with any specific embodiment or combination of implementations of the disclosed methods.

What is claimed is:

1. A system for detecting fraudulent activity using account analytics, the system comprising:
one or more processors; and
memory having instructions stored thereon that, when executed by the one or more processors, cause the system to:
obtain an interaction record for an interaction between a remote device and a user account via an interaction channel, wherein the interaction comprises an attempt to access the user account;
obtain historical data relating the user account and the interaction channel, wherein the historical data comprises one or more historical interaction records relating to the user account and activity records relating to the interaction channel;
calculate a threat score for the user account based on the interaction record and the one or more historical interaction records, wherein the threat score indicates a likelihood that the user account is subject to fraudulent activity;
generate a database record based on the interaction record that includes the threat score; and
initiate a corrective action if the threat score exceeds a predetermined threshold.

2. The system of claim 1, wherein the instructions further cause the system to obtain a risk score for the interaction channel, and wherein the threat score is calculated based further on the risk score.

3. The system of claim 1, wherein the corrective action comprises suspending the user account to prevent access.

4. The system of claim 1, wherein the corrective action comprises one of blocking or blacklisting the interaction channel.

5. The system of claim 1, wherein the instructions further cause the system to generate and display a user interface that indicates details of the interaction and the threat score.

6. The system of claim 1, wherein the interaction record is obtained from a client device via an application programing interface (API).

7. The system of claim 1, wherein the interaction record comprises channel activity data for the interaction channel, authentication activity data relating to the user account, and behavioral activity data relating to the interaction.

8. The system of claim 7, wherein the behavioral activity data comprises one or more of a time of day of the interaction, an indication of number of access attempts made against the user account, an indication of an attempt to change security details of the user account, a length of the interaction, and an indication of whether a user of the remote device attempted to transfer to a customer service agent.

9. The system of claim 1, wherein the interaction and the historical data relating the user account and the interaction channel are obtained in real-time such that the threat score is calculated in real-time or near real-time.

10. The system of claim 1, wherein the threat score is calculated using a machine learning model, and wherein the machine learning model is continuously retrained based on interaction data and user account data.

11. A method for detecting fraudulent account activity, the method comprising:
obtaining an interaction record for an interaction between a remote device and a user account via an interaction channel, wherein the interaction comprises an attempt to access the user account;
obtaining historical data relating the user account and the interaction channel, wherein the historical data comprises one or more historical interaction records relating to the user account and activity records relating to the interaction channel;
calculating a threat score for the user account based on the interaction record and the one or more historical interaction records, wherein the threat score indicates a likelihood that the user account is subject to fraudulent activity;
generating a database record based on the interaction record that includes the threat score; and
initiating a corrective action if the threat score exceeds a predetermined threshold.

12. The method of claim 11, further comprising obtaining a risk score for the interaction channel, wherein the threat score is calculated based further on the risk score.

13. The method of claim 11, wherein the corrective action comprises one of suspending the user account to prevent access, blocking the interaction channel, or blacklisting the interaction channel.

14. The method of claim 11, further comprising generating and displaying a user interface that indicates details of the interaction and the threat score.

15. The method of claim 11, wherein the interaction record is obtained from a client device via an application programing interface (API).

16. The method of claim 11, wherein the interaction record comprises channel activity data for the interaction channel, authentication activity data relating to the user account, and behavioral activity data relating to the interaction.

17. The method of claim 16, wherein the behavioral activity data comprises one or more of a time of day of the interaction, an indication of number of access attempts made against the user account, an indication of an attempt to change security details of the user account, a length of the interaction, and an indication of whether a user of the remote device attempted to transfer to a customer service agent.

18. The method of claim 11, wherein the interaction and the historical data relating the user account and the interaction channel are obtained in real-time such that the threat score is calculated in real-time or near real-time.

19. The method of claim 11, wherein the threat score is calculated using a machine learning model, and wherein the machine learning model is continuously retrained based on interaction data and user account data.

20. A non-transitory computer readable medium having instructions stored thereon that, when executed by one or more processors of a computing device, cause the computing device to:
obtain an interaction record for an interaction between a remote device and a user account via an interaction channel, wherein the interaction comprises an attempt to access the user account;
obtain historical data relating the user account and the interaction channel, wherein the historical data comprises one or more historical interaction records relating to the user account and activity records relating to the interaction channel;
calculate a threat score for the user account based on the interaction record and the one or more historical interaction records, wherein the threat score indicates a likelihood that the user account is subject to fraudulent activity; and
initiate a corrective action if the threat score exceeds a predetermined threshold.
